(19) United States
(12) Patent Application Publication
(10) Pub. No.: US 2012/0154909 A1
(43) Pub. Date: Jun. 21, 2012

(54) STEREOSCOPIC DISPLAY SYSTEM, EYEGLASSES DEVICE, DISPLAY DEVICE, AND IMAGE DISPLAY SYSTEM

(75) Inventor: Tadashi Fukami, Kanagawa (JP)

(73) Assignee: SONY CORPORATION, Tokyo (JP)

(21) Appl. No.: 13/327,144

(22) Filed: Dec. 15, 2011

(30) Foreign Application Priority Data
Dec. 21, 2010 (JP) 2010-284357

(51) Int. Cl. G02B 27/22

(52) U.S. Cl. 359/464

(57) ABSTRACT

An eyeglasses device includes: an attitude detection section detecting attitude information which represents a tilt relative to a horizontal direction; and a separation unit optically separating a left eye image and a right eye image from perspective images selected from a plurality of supplied perspective images and displayed on a display device, based on the obtained attitude information.

### CROSS REFERENCES TO RELATED APPLICATIONS

The present application claims priority to Japanese Priority Patent Application JP 2010-284357 filed in the Japan Patent Office on Dec. 21, 2010, the entire content of which is hereby incorporated by reference.

### BACKGROUND

The present disclosure relates to a stereoscopic display system in which stereoscopic vision is possible by eyeglasses, an eyeglasses device, a display device, and an image display system.

In recent years, a stereoscopic display system that achieves stereoscopic vision has been attracting attention. The stereoscopic vision displays a left eye image and a right eye image (perspective image) that have parallax to each other. By observing these images with the left and right eyes respectively, it is possible for an observer to recognize them as a stereoscopic image having a depth. A display system using eyeglasses is one of such a stereoscopic display system. In this display system, eyeglasses separate the left eye image and the right eye image displayed on a display section optically, allowing the left eye of the observer to observe the left eye image and the right eye to observe the right eye image. With such a stereoscopic display systems, for example, some system uses shutter eyeglasses having a left eye shutter and a right eye shutter that perform opening and closing operations independently and other system uses polarization eyeglasses having a left eye polarization plate and a right eye polarization plate with different directions of transmission axes to each other (for example, Japanese Unexamined Patent Application Publication No. H02-233088).

In general, an observer observes displayed images with various attitude. For example, when the observer inclines his/her head, the direction of parallax of the left eye image and the right eye image is shifted from the direction connecting the left eye and the right eye of the observer, resulting in deterioration of the displayed image. Therefore, some stereoscopic display system generates perspective images according to the attitude of eyeglasses. For example, in Japanese Patent No. 3976040, a stereoscopic display system generating perspective images according to the tilt of eyeglasses is proposed. In this stereoscopic display system, even when the observer tilts his/her head, a suitable perspective image is generated in response to that motion, making it possible to perform suitable stereoscopic vision.

As for a method of generating perspective images, several proposals are offered. For example, in Japanese Unexamined Patent Application Publication No. 2010-171608, an image processor is proposed, in which a left eye image and a right eye image are generated by shifting a two-dimension image to left and right.

### SUMMARY

In the stereoscopic display system according to Japanese Patent No. 3976040, since perspective images are generated according to the tilt of eyeglasses, processing may be complicated. No descriptions are given at all to the case where the observer observes perspective images with various attitude in the stereoscopic display system according to Japanese Unexamined Patent Application Publication No. H02-233088 and Japanese Unexamined Patent Application Publication No. 2010-171608.

It is desirable to provide a stereoscopic display system in which stereoscopic vision becomes possible with a simple structure independent of an attitude of an observer, an eyeglasses device, a display device, and an image display system.

A stereoscopic display system according to an embodiment of the technology includes: one or more eyeglasses devices; and a display device selecting perspective images from a plurality of supplied perspective images to display the selected perspective images, and obtaining attitude information which represents a tilt of each of the eyeglasses devices relative to a horizontal direction. Each of the eyeglasses devices optically separates a left eye image and a right eye image from the selected perspective images displayed on the display device, based on the obtained attitude information.

An eyeglasses device according to an embodiment of the technology includes: an attitude detection section detecting attitude information which represents a tilt relative to a horizontal direction; and a separation unit optically separating a left eye image and a right eye image from perspective images selected from a plurality of supplied perspective images and displayed on a display device, based on the obtained attitude information.

A display device according to an embodiment of the technology includes: a display device selecting perspective images from a plurality of supplied perspective images to display the selected perspective images; and an acquisition unit obtaining attitude information which represents a tilt of one or more eyeglasses devices relative to a horizontal direction. Each of the eyeglasses devices optically separates a left eye image and a right eye image from the selected perspective images displayed on the display device, based on the obtained attitude information.

An image display system according to an embodiment of the technology includes: an image pick-up unit picking up a plurality of perspective images from an object, and a stereoscopic display system performing stereoscopic display based on the plurality of perspective images, in which the stereoscopic display system includes: one or more eyeglasses devices; and a display device selecting perspective images from the plurality of supplied perspective images to display the selected perspective images, and obtaining attitude information which represents a tilt of each of the eyeglasses devices relative to a horizontal direction, wherein each of the eyeglasses devices optically separates a left eye image and a right eye image from the selected perspective images displayed on the display device, based on the obtained attitude information.

In the stereoscopic display system, the eyeglasses device, the display device, and the image display system according to the embodiments of the technology, the perspective images including the left eye image and the right eye image are selected from the plurality of supplied perspective images, and are displayed on the display section. The left eye image and the right eye image are based on the obtained attitude information.

Advantageously, each of the eyeglasses devices includes an attitude detection section detecting its own attitude, and the display device obtains the attitude information from the attitude detection section in each of the eyeglasses devices.

Advantageously, the display device includes an eyeglasses detection section detecting the attitude of each of the eyeglasses devices.

Advantageously, the eyeglasses detection section picks up an image of each of the eyeglasses devices and detects the attitude of each of the eyeglasses devices based on the picked-up images.

Advantageously, the display device selects a pair of perspective images from the plurality of supplied perspective images based on the attitude information.

Advantageously, each of the eyeglasses devices is configured as a shutter-type eyeglasses having a left eye shutter and a right eye shutter, and the display device displays the pair of perspective images alternately in a time-divisional manner, and controls the shutter-type eyeglasses to allow the left eye shutter and the right eye shutter to open and to close with a timing based on the attitude information.

Advantageously, each of the eyeglasses devices is configured as a polarization-type eyeglasses having a left eye polarization plate and a right eye polarization plate which have transmission axes intersecting with each other, and the display device displays, based on the attitude information, the left eye image and the right eye image as the pair of perspective image while allowing the left eye image and the right eye image to be polarized in intersecting directions with each other.

Advantageously, the display device displays the left eye image to allow an observer to observe the left eye image through the left eye polarization plate, and displays the right eye image to allow the observer to observe the right eye image through the right eye polarization plate.

Advantageously, each of the eyeglasses devices is configured as a shutter-type eyeglasses having a left eye shutter and a right eye shutter, and the display device obtains the attitude information for each of the shutter-type eyeglasses to display the plural pairs of perspective images, and controls each of the shutter-type eyeglasses to allow the left eye shutter and the right eye shutter to open and to close with a timing based on the attitude information.

Advantageously, two pairs of perspective images are used as the plural pairs of perspective images.

According to the stereoscopic display system, the eyeglasses device, the display device, and the image display system of the embodiments of the technology, the perspective images including the left eye image and the right eye image based on the attitude information are selected from the plurality of supplied perspective images to display the selected perspective images. Therefore, it is possible to achieve stereoscopic vision with a simple structure regardless of observers' attitude.

It is to be understood that both foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram representing an example of configuration of a stereoscopic display system according to a first embodiment of the technology.

FIG. 2 is a schematic diagram for illustrating perspective images.

FIG. 3 is a block diagram representing an example of configuration of an image processing section shown in FIG. 1.

FIG. 4 is a block diagram representing an example of configuration of shutter eyeglasses shown in FIG. 1.

FIGS. 5A to 5C are schematic diagrams for illustrating operation of an attitude detection section shown in FIG. 4.

FIG. 6 is a configuration diagram representing an example of configuration of an image pick-up unit that generates perspective images.

FIG. 7 is an illustration diagram representing an example of operation of the image pick-up unit shown in FIG. 6.

FIGS. 8A and 8B are schematic diagrams representing an example of operation of the stereoscopic display system shown in FIG. 1.

FIG. 9 is an illustration diagram representing another example of operation of the stereoscopic display system shown in FIG. 1.

FIG. 10 is an illustration diagram representing another example of operation of the stereoscopic display system shown in FIG. 1.

FIG. 11 is an illustration diagram representing another example of operation of the stereoscopic display system shown in FIG. 1.

FIGS. 12A to 12C are schematic diagrams illustrating the operation of an attitude detection section according to a modification example of the first embodiment.

FIG. 13 is a block diagram representing an example of configuration of the image processing section according to the modification example of the first embodiment.

FIG. 14 is a schematic diagram illustrating perspective images of the stereoscopic display system according to the modification example of the first embodiment.

FIG. 15 is a block diagram representing an example of configuration of the stereoscopic display system according to another modification example of the first embodiment.

FIG. 16 is a block diagram representing an example of configuration of a stereoscopic display system according to a second embodiment of the technology.

FIG. 17 is a block diagram representing an example of configuration of an image processing section shown in FIG. 16.

FIG. 18 is an illustration diagram representing an example of operation of the stereoscopic display system shown in FIG. 16.

FIG. 19 is an illustration diagram representing another example of operation of the stereoscopic display system shown in FIG. 16.

FIG. 20 is an illustration diagram representing another example of operation of the stereoscopic display system shown in FIG. 16.

FIG. 21 is a block diagram representing an example of configuration of a stereoscopic display system according to a third embodiment of the technology.

FIG. 22 is a block diagram representing an example of configuration of an image processing section shown in FIG. 21.

FIG. 23 is an illustration diagram representing an example of operation of the stereoscopic display system shown in FIG. 21.

FIG. 24 is an illustration diagram representing another example of operation of the stereoscopic display system shown in FIG. 21.

FIG. 25 is an illustration diagram representing another example of operation of the stereoscopic display system shown in FIG. 21.

### DETAILED DESCRIPTION

In the following, detailed descriptions will be given on embodiments of the technology while referring to drawings. Descriptions will be given in order as follows.
1. First embodiment
2. Second embodiment
3. Third embodiment

### First Embodiment

### EXAMPLE OF CONFIGURATION

### EXAMPLE OF OVERALL CONFIGURATION

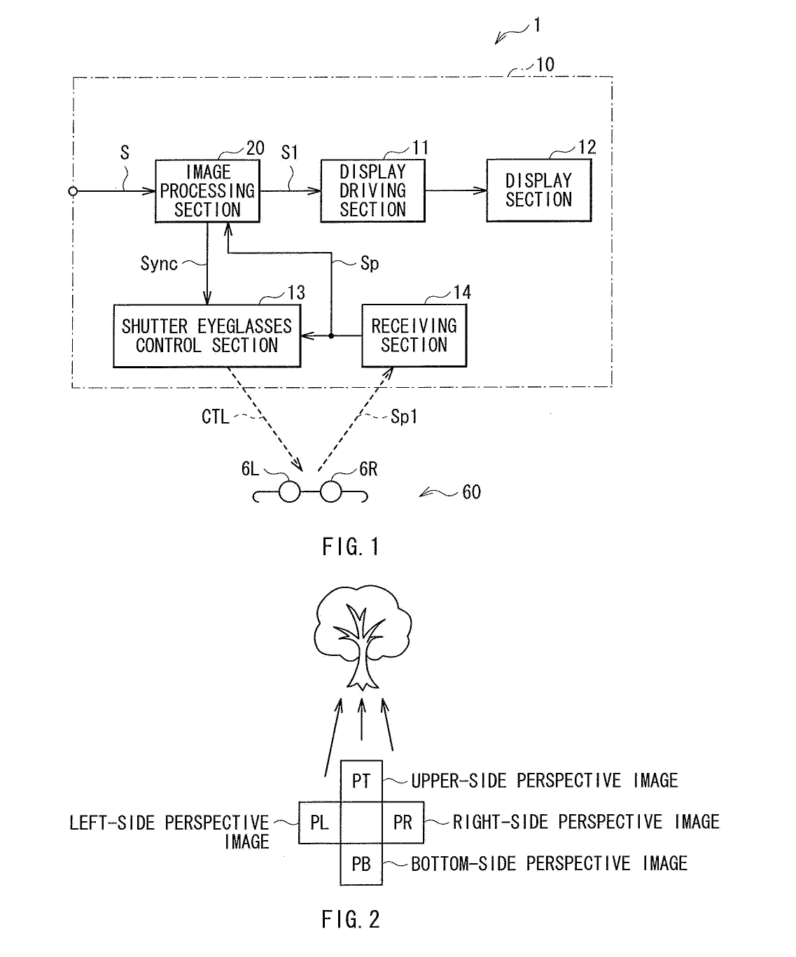

FIG. 1 shows an example of configuration of a stereoscopic display system according to a first embodiment of the technology. The stereoscopic display system 1 is a display system that uses shutter eyeglasses (shutter-type eyeglasses). Since the eyeglasses device, display device, and image display system according to embodiments of the technology are embodied by the present embodiment, descriptions thereof will be given in conjunction therewith. The stereoscopic display system 1 includes a display device 10 and shutter eyeglasses 60.

### [Display Device 10]

The display device 10 displays left eye images L and right eye images R based on perspective image signals S including perspective images related to two or more viewpoints, thereby controlling the shutter eyeglasses 60 in synchronization with the display of the left eye images L and right eye images R. The display device 10 includes an image processing section 20, a display driving section 11, a display section 12, a shutter eyeglasses control section 13, and a receiving section 14.

FIG. 2 schematically represents two or more perspective images included by perspective image signals S. The perspective image signals S, in this example, include four perspective images (a left-side perspective image PL, a right-side perspective image PR, an upper-side perspective image PT, and a bottom-side perspective image PB). These four perspective images are images that are obtainable by observing an object from different directions. Specifically, the left-side perspective image PL is an image obtained by viewing the object from slightly left from the front, the right-side perspective image PR is an image obtained by viewing the object from slightly right from the front, upper-side perspective image PT is an image obtained by viewing the object from slightly upper-side from the front, and bottom-side perspective image PB is an image obtained by viewing the object from slightly bottom-side from the front.

The image processing section 20 generates image signals S1 based on the perspective image signals S and the attitude signal Sp to supply them to the display driving section 11, and generates synchronous signals Sync to supply them to the shutter eyeglasses control section 13.

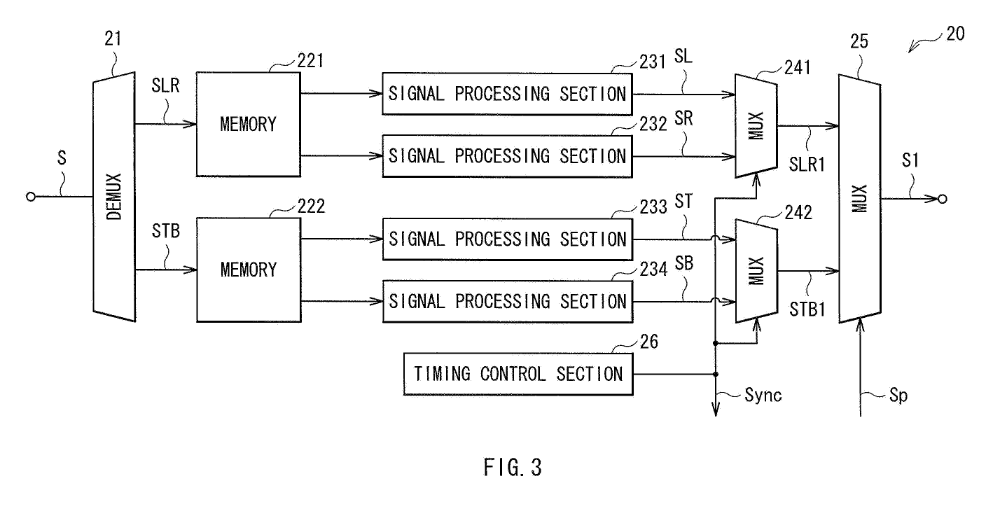

FIG. 3 shows an example of configuration of the image processing section 20. The image processing section 20 includes a demultiplexer (DEMUR) 21, memories 221 and 222, signal processing sections 231 to 234, a timing control section 26, and multiplexers (MUX) 241, 242, and 25.

The demultiplexer 21 separates image signals SLR including the left-side perspective image PL and right-side perspective image PR from the perspective image signals S to supply them to the memory 221, and separates image signals STB including the upper-side perspective image PT and bottom-side perspective image PB to supply them to the memory 222. In this example, the image signals SLR are encoded left-side perspective images PL and right-side perspective images PR by a side-by-side (SBS) method. The image signals STB are encoded upper-side perspective image PT and bottom-side perspective image PB by the SBS method.

The memories 221 and 222 are a frame memory that stores one frame of image signals SLR and STB, respectively. Specifically, the memory 221 stores one frame of the image signal SLR, wherein the left-side perspective image PL portion of that one frame is extended into a one-frame image to be supplied to a signal processing section 231, and the right-side perspective images PR portion is extended into a one-frame image to be supplied to a signal processing section 232. Similarly, the memory 222 stores one frame of the image signals STB, wherein the upper-side perspective image PT portion of that one frame is extended into a one-frame image to be supplied to a signal processing section 233, and the bottom-side perspective image PB portion is extended into a one-frame image to be supplied to a signal processing section 234.

The signal processing sections 231 to 234 perform image signal processing such as decoding and achieving high quality images, for image signals supplied by the memories 221 and 222. Specifically, the signal processing section 231 performs image signal processing to the image signals including the left-side perspective image PL supplied by the memory 221 to generate the image signal SL. The signal processing section 232 performs image signal processing to image signals including the right-side perspective images PR supplied by the memory 221 to generate the image signal SR. The signal processing section 233 performs image signal processing to image signals including the upper-side perspective image PT supplied by the memory 222 to generate the image signal ST. The signal processing section 234 performs image signal processing to image signals including the bottom-side perspective image PB supplied by the memory 222 to generate the image signal SB.

The timing control section 26 generates the synchronous signal Sync to supply the same to multiplexers 241 and 242, and also supplies the same to the shutter eyeglasses control section 13.

The multiplexers 241 and 242 multiplex signals input thereto respectively based on the synchronous signal Sync. Specifically, the multiplexer 241 multiplexes the image signal SL supplied by the signal processing section 231 and the image signal SR supplied by the signal processing section 232 such that the frame image of the left-side perspective image PL and the frame image of the right-side perspective images PR are arranged alternately, and output the resultant as an image signal SLR1. Similarly, the multiplexer 242 multiplexes the image signal ST supplied by the signal processing section 233 and the image signal SB supplied by the signal processing section 234 such that the frame image of the upper-side perspective image PT and the frame image of the bottom-side perspective image PB are arranged alternately, and output the resultant as an image signal STB1.

The multiplexer 25 selects and outputs either the image signals SLR1 supplied by the multiplexer 241 or the image signals STB 1 supplied by the multiplexer 242 based on the attitude signal Sp. Specifically, the multiplexer 25, to be described later, selects and outputs the image signals SLR1 under a condition where the shutter eyeglasses 60 are horizontal and selects and outputs the image signals STB1 under a condition where the shutter eyeglasses 60 are lying.

Thus, as will be described later, the image processing section 20 outputs the image signal in which the left-side perspective image PL and right-side perspective image PR are multiplexed under a condition where the shutter eyeglasses 60 are horizontal, and outputs the image signal in which the upper-side perspective image PT and bottom-side perspective image PB are multiplexed under a condition where the shutter eyeglasses 60 are lying. Therefore, the image processing section 20 selects and outputs a pair of perspective images from the perspective image signal S based on the attitude of the shutter eyeglasses 60.

In FIG. 1, the display driving section 11 drives the display section 12 based on the image signal S1 supplied from the image processing section 20. The display section 12 displays a display image D including the left eye image L and right eye image R based on the drive signal supplied by the display driving section 11. Specifically, the display section 12 displays the frame image of the left eye image L and that of the right eye image R alternately in a time-divisional manner, enabling, what is called, double speed display.

The shutter eyeglasses control section 13 controls the shutter eyeglasses 60 based on the synchronous signal Sync supplied by the image processing section 20 and the attitude signal Sp supplied by the receiving section 14. Specifically, the shutter eyeglasses control section 13 has functions to prepare the shutter signal CTL to control the shutter 60, and supply the same to the shutter eyeglasses 60 via such as radio communications.

The receiving section 14 receives the attitude signal Sp1 supplied by the shutter eyeglasses 60, and supplies the same, as a position signal Sp, to the image processing section 20 and the shutter eyeglasses control section 13.

### [Shutter Eyeglasses 60]

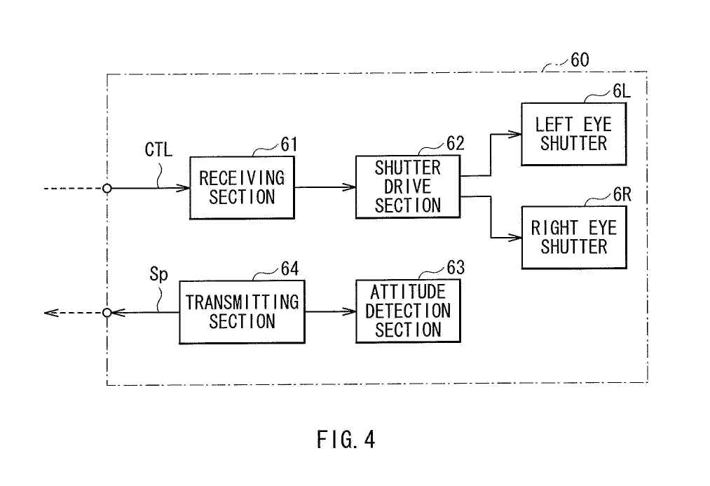

FIG. 4 shows an example of configuration of the shutter eyeglasses 60. The shutter eyeglasses 60 are an eyeglasses-type shutter device that an observer wears. The shutter eyeglasses 60 include a left eye shutter 6L, a right eye shutter 6R, a receiving section 61, a shutter drive section 62, an attitude detection section 63, and a transmitting section 64.

It is possible for the left eye shutter 6L and right eye shutter 6R to independently open and close. They are made of, for example, a light shield shutter such as a liquid crystal shutter. Open and close conditions of each of the left eye shutter 6L and right eye shutter 6R are controlled by a shutter control signal CTL.

The receiving section 61 receives the shutter control signal CTL supplied by the shutter eyeglasses control section 13 of the display device 10. The shutter drive section 62 drives the left eye shutter 6L and right eye shutter 6R based on the shutter control signal CTL received by the receiving section 61 to control the opening and closing operation. The left eye shutter 6L and right eye shutter 6R perform opening and closing operation of the shutter based on the drive signals supplied by the shutter drive section 62.

The attitude detection section 63 detects the attitude of the shutter eyeglasses 60, and includes, for example, a gravity sensor. The attitude detection section 63 detects the attitude of the shutter eyeglasses 60 in order to detect whether an observer wearing the shutter eyeglasses 60 observes the display image of the display section 12 while standing or sitting, or observes the display image while lying, for example.

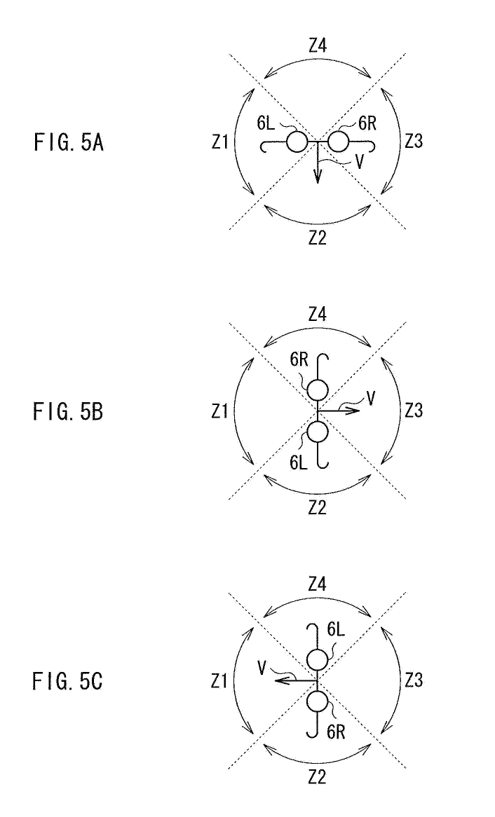

FIGS. 5A to 5C show the attitude of the shutter eyeglasses 60. FIG. 5A shows a state of being horizontal. FIG. 5B shows a state of lying in the left direction. FIG. 5C shows a state of lying in the right direction. In FIGS. 5A to 5C, for the sake of convenience of explanation, a vector V directed to the downward direction of the shutter eyeglasses 60 is shown.

The state shown in FIG. 5A corresponds to, for example, a state where an observer observes a display image while standing or sitting. The state shown in FIG. 5B corresponds to, for example, a state where an observer observes a display image while lying in the left direction. The state shown in FIG. 5C corresponds to, for example, a state where an observer observes a display image while lying in the right direction.

The attitude detection section 63 detects an orientation of the shutter eyeglasses 60. Specifically, in this example, by detecting into which region the vector V is directed among four regions Z1 to Z4 that are specified in advance as a reference of the direction of a gravitational force, the attitude detection section 63 detects which is the state of the shutter eyeglasses 60: a state of being horizontal, a state of lying in the left direction, and a state of lying in the right direction. Then, the attitude detection section 63 supplies detection results (attitude information) to the transmitting section 64.

The transmitting section 64 supplies the detection results of the attitude detection section 63 as an attitude signal Sp1 to the display section 10 by such as radio communications.

Based on the above structure, in the display device 10, the multiplexer 25 of the image processing section 20 selects the image signal SLR1 (image signals including the left-side perspective image PL and the right-side perspective image PR) supplied by the multiplexer 241 and outputs the same as the image signal S1, under the state where the shutter eyeglasses 60 are horizontal as shown in FIG. 5A. The display section 12 displays the frame image of the left-side perspective image PL and that of the right-side perspective image PR alternately in a time-divisional fashion. The shutter eyeglasses control section 13 controls the shutter eyeglasses 60 so that an observer visually confirms the left-side perspective image PL with the left eye and the right-side perspective image PR with the right eye.

Under the state where the shutter eyeglasses 60 are lying, in the display device 10, the multiplexer 25 of the image processing section 20 selects the image signal STB1 (image signal including the upper-side perspective image PT and the bottom-side perspective image PB) supplied by the multiplexer 242 and outputs the same as the image signal S1, as shown in FIGS. 5B and 5C. The display section 12 displays the frame image of the upper-side perspective image PT and that of the bottom-side perspective image PB alternately in a time-divisional fashion. The shutter eyeglasses control section 13, as shown in FIG. 5B, under the condition where the shutter eyeglasses 60 are lying in the left direction, controls the shutter eyeglasses 60 so that an observer visually confirms the bottom-side perspective image PB with the left eye and the upper-side perspective image PT with the right eye. The shutter eyeglasses control section 13, as shown in FIG. 5C, under the condition where the shutter eyeglasses 60 are lying in the right direction, controls the shutter eyeglasses 60 so that an observer visually confirms the upper-side perspective image PT with the left eye and the bottom-side perspective image PB with the right eye.

### [Image-Pickup Unit 90]

Next, descriptions will be given to the image pick-up unit 90 as an example of a device that generates the perspective image signal S supplied to the stereoscopic display system 1.

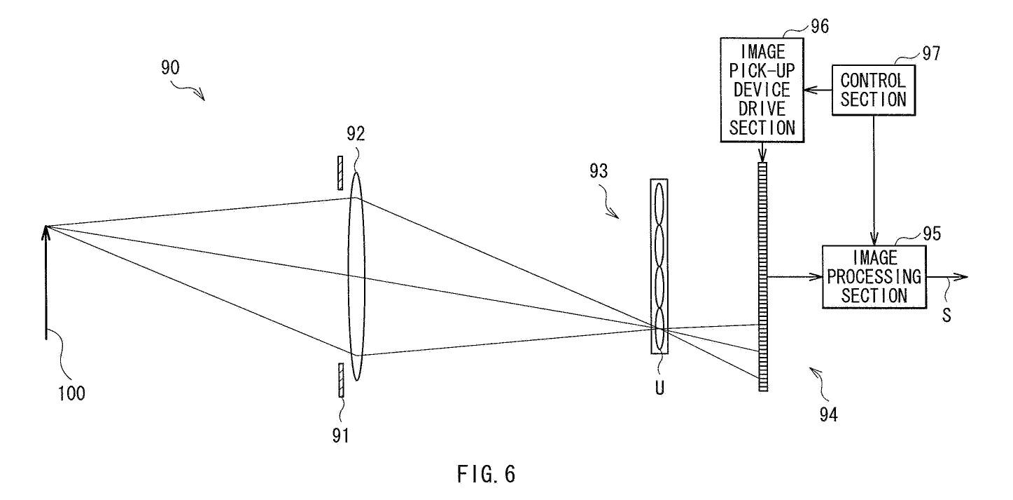

FIG. 6 shows an example of an overall configuration of the image pick-up unit 90. The image pick-up unit 90 picks up an image of the object 100 and performs the image processing thereon to output the perspective image signal S. The image pick-up unit 90 includes an aperture stop 91, an image pick-up lens 92, a micro lens array 93, an image pick-up device 94, an image processing section 95, an image pick-up device drive section 96, and a control section 97.

The aperture stop 91 is an optical aperture stop of the image pick-up lens 92. The image pick-up lens 92 is a main lens for picking up an image of an object, and may be a general image pick-up lens used in a camera such as a video camera and a still camera.

The micro lens array 93 has a configuration in which micro lenses U are arranged, and is disposed on a focal plane (an image plane) of the image pick-up lens 92. Each of the micro lenses U may be a lens such as a solid lens, a liquid crystal lens, and a diffraction lens. To this micro lens U, two or more pixels in the image pick-up device 94 are allocated.

The image pick-up device 94 receives light beams from the micro lens array 93 to generate image data (image pick-up data) containing two or more image pixel data, and is disposed on a focal plane (an image plane) of the micro lens array 93. The image pick-up device 94 may be a two-dimensional solid-state image pick-up device such as two or more CCDs (Charge-Coupled Device) and CMOSs (Complementary Metal-Oxide Semiconductor) arranged in matrix. M×N (M and N each are an integer) image pixels are disposed on a photosensitive surface (a surface on the micro lens array 93 side) of the image pick-up device 94. One micro lens U in the micro lens array 93 is allocated to two or more image pixels. For example, with the number (M×N) of image pixels on the photosensitive surface, one micro lens U is allocated to 3×3=9 image pixels.

The image processing section 95 performs predetermined image processing to image data obtained by the image pick-up device 94 to generate the perspective image signal S.

The image pick-up device drive section 96 drives the image pick-up device 94 to control its light-receiving operation.

The control section 97 controls the operation of the image processing section 95 and the image pick-up device drive section 96, and may be configured by a microcomputer, for example.

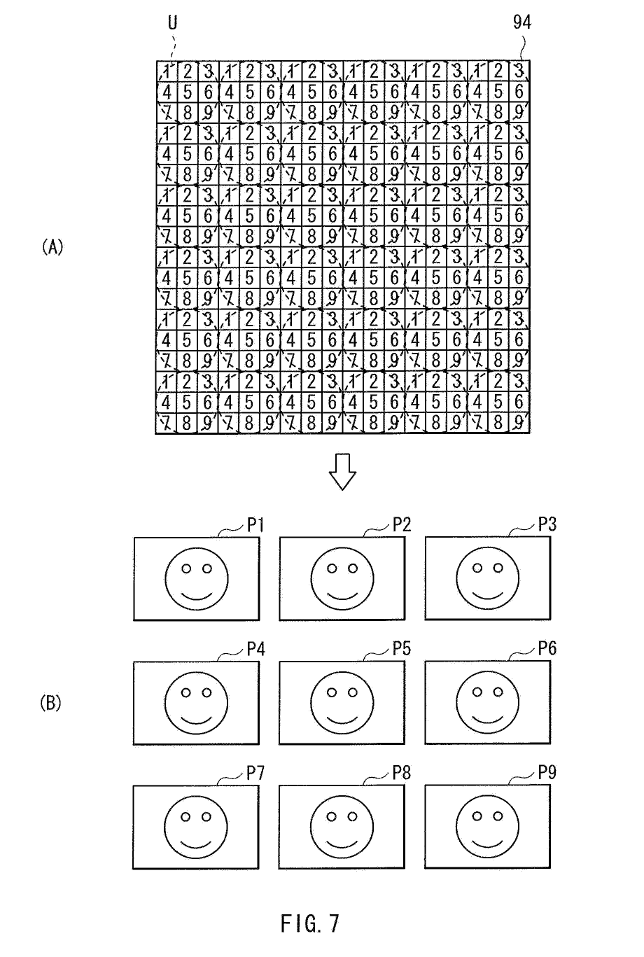

Part (A) and Part (B) of FIG. 7 schematically show the operation of the image pick-up unit 90. Part (A) of FIG. 7 shows a relation between the micro lenses U of the micro lens array 93 and the image pixels of the image pick-up unit 90. Part (B) of FIG. 7 shows the plurality of perspective images P1 to P9 generated by the image pick-up unit 90.

In the image processing section 95, the pixel data of the image pixels that are in the same positions among the micro lenses U (data in the regions numbered with the same number in (A) of FIG. 7) are extracted respectively from the image data obtained by the image pick-up device 94, and these extracted pixel data are synthesized mutually. Thus, as shown in (B) of FIG. 7, nine perspective images P1 to P9 are generated in this example. The generated perspective images P1 to P9 are observed images having different perspectives from one another. In this example, the resolutions (the number of pixels) thereof are 36 (=6×6), respectively. Here, the perspective image P2 corresponds to the upper-side perspective image PT shown in FIG. 2, the perspective image P4 corresponds to the left-side perspective image PL, the perspective image P6 corresponds to the right-side perspective image PR, and the perspective image P8 corresponds to the bottom-side perspective image PB. Then, the image processing section 95 outputs the perspective image signals S including these nine perspective images P1 to P9.

Incidentally, in this example, the image pick-up unit 90 generates the perspective image signal S, although it is not limited thereto. Other image pick-up unit or a personal computer or the like may generate the signal in place thereof. The perspective image signal S generated by the image pick-up unit 90 may be directly input into the stereoscopic display system 1. The perspective image signals S recorded in a recording medium such as a recorded Blu-ray Disc (Registered Trademark) may be input by being reproduced by reproduction equipment.

Here, the left eye shutter 6L and the right eye shutter 6R correspond to a “separation unit” according to one embodiment of the technology. The receiving section 14 corresponds to an “acquisition unit” according to one embodiment of the technology. The shutter eyeglasses control section 13 corresponds to an “eyeglasses control section” according to one embodiment of the technology.

### [Operation and Action]

Next, descriptions will be given to operation and action of the stereoscopic display system 1 of the embodiment of the technology.

### [Outline of Overall Operation]

Firstly, descriptions will be given to an outline of the overall operation of the stereoscopic display system 1. In the shutter eyeglasses 60, the attitude detection section 63 detects the attitude of the shutter eyeglasses 60. The transmitting section 64 supplies the detection results thereof to the display device 10 as the attitude signal Sp1. In the display device 10, the receiving section 14 receives the attitude signal Sp1 and supplies the same to the image processing section 20 and the shutter eyeglasses control section 13 as the attitude signal Sp. The image processing section 20 generates the image signal S1 based on the supplied perspective image signal S and the attitude signal Sp to supply the same to the display driving section 11, and generates the synchronous signal Sync to supply the same to the shutter eyeglasses control section 13. The display driving section 11 drives the display section 12 based on the image signal S1. The display section 12 displays the left eye image L and the right eye image R alternately in a time-divisional fashion based on the drive signal supplied by the display driving section 11. The shutter eyeglasses control section 13 generates the shutter control signal CTL based on the synchronous signal Sync and the attitude signal Sp to supply the same to the shutter eyeglasses 60. In the shutter eyeglasses 60, the receiving section 61 receives the shutter control signal CTL, and the shutter drive section 62 controls the opening and closing operation of the left eye shutter 6L and the right eye shutter 6R based on the shutter control signal CTL received by the receiving section 61. The left eye shutter 6L and the right eye shutter 6R perform the opening and closing operation of the shutter based on the drive signal supplied by the shutter drive section 62.

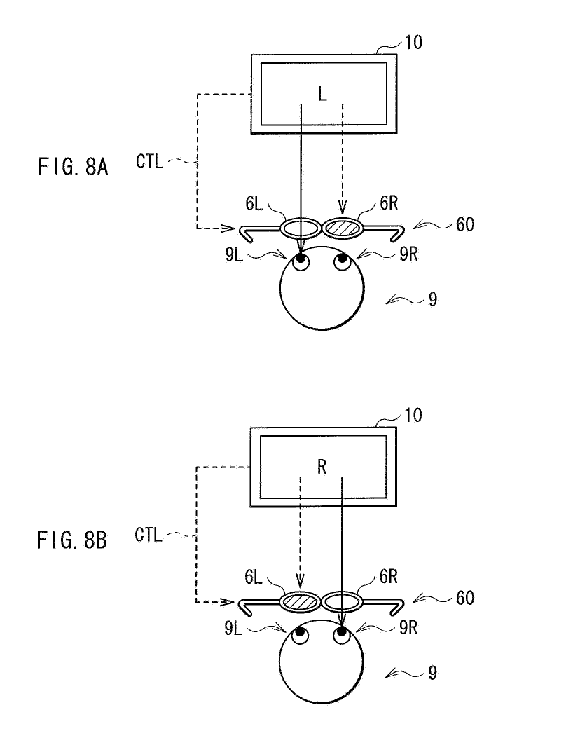

FIGS. 8A and 8B schematically show display operation of the stereoscopic display system 1. FIG. 8A shows operation when the left eye image L is displayed. FIG. 8B shows operation when the right eye image R is displayed. When the display device 10 displays the left eye image L, in the shutter eyeglasses 60, the left eye shutter 6L becomes an open state and the right eye shutter 6R becomes a closed state, as shown in FIG. 8A. At this time, an observer 9 observes the left eye image L with the left eye 9L. On the other hand, when the display device 10 displays the right eye image R, in the shutter eyeglasses 60, the left eye shutter 6L becomes the closed state and the right eye shutter 6R becomes the open state, as shown in FIG. 8B. At this time, the observer 9 observes the right eye image R with the right eye 9R. When these operations are repeated alternately, since parallax exists between the left eye image L and right eye image R, it is possible for the observer 9 to recognize images composed of these series of picture images as stereoscopic images having depth.

### [Detailed Operation]

Next, descriptions will be given to detailed operation of the stereoscopic display system 1.

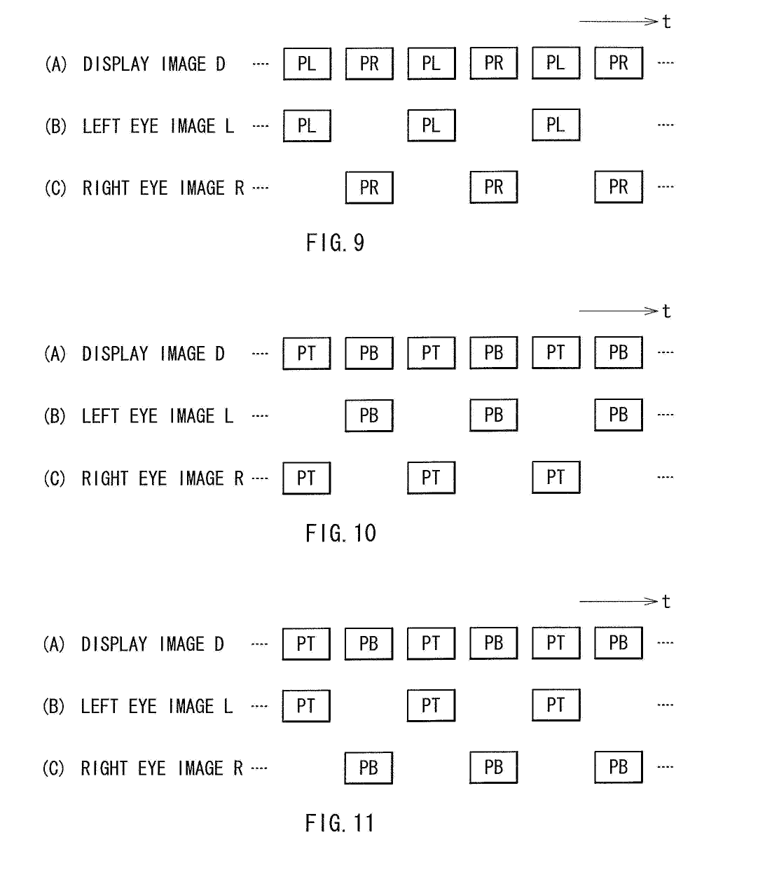

FIGS. 9 to 11 show examples of the operation of the stereoscopic display system 1 in response to the attitude of the shutter eyeglasses 60. Part (A) to Part (C) of FIG. 9 show an example of the operation in a state where the shutter eyeglasses 60 are horizontal. Part (A) to Part (C) of FIG. 10 show an example of the operation in a state where the shutter eyeglasses 60 are lying in the left direction. Part (A) to Part (C) of FIG. 11 show an example of the operation in a state where the shutter eyeglasses 60 are lying in the right direction. Part (A) of each of FIGS. 9 to 11 shows a display image D in the display section 12. Part (B) of each of FIGS. 9 to 11 shows the left eye image L. Part (C) of each of FIGS. 9 to 11 shows the right eye image R.

As shown in FIGS. 5A to 5C, the attitude detection section 63 of the shutter eyeglasses 60 detects the attitude thereof, and the transmitter section 64 supplies detection results to the display device 10 as the attitude signal Sp1. In the display device 10, the receiving section 14 receives the attitude signal Sp1 to supply the same to the image processing section 20 and the shutter eyeglasses control section 13 as the attitude signal Sp.

In a state where the shutter eyeglasses 60 are horizontal (FIG. 5A), the multiplexer 25 of the image processing section 20 selects the image signal SLR1 (image signal including the left-side perspective image PL and right-side perspective image PR) based on the attitude signals Sp showing that state, and outputs the same as the image signal S1. Thereby, as shown in (A) of FIG. 9, the display device 10 displays the display image D including the left-side perspective image PL and the right-side perspective image PR. On the other hand, based on the attitude signal Sp, the shutter eyeglasses control section 13 controls the shutter eyeglasses 60 using the shutter control signal CTL, so as to make the left eye shutter 6L of the shutter eyeglasses 60 an open state and make the right eye shutter 6R a closed state during a period in which the frame image of the left-side perspective image PL is displayed on the display section 12, and to make the left eye shutter 6L of the shutter eyeglasses 60 a close state and make the right eye shutter 6R an open state during a period in which the frame image of the right-side perspective image PR is displayed. This makes it possible for an observer to visually confirm the left-side perspective image PL with the left eye and the right-side perspective image PR with the right eye. That is, in the stereoscopic display system 1, the left-side perspective image PL is displayed as the left eye image L ((B) of FIG. 9) and the right-side perspective image PR as the right eye image R ((C) of FIG. 9).

Thus, under a state where the shutter eyeglasses 60 are horizontal, as shown in FIG. 2, the left-side perspective image PL and the right-side perspective image PR having a parallax in the lateral direction to each other are displayed as the display image D. Thereby, it is possible for the observer to recognize the display image D as a stereoscopic image.

In a state where the shutter eyeglasses 60 are lying in the left direction (FIG. 5B), the multiplexer 25 of the image processing section 20 selects the image signal STB1 (image signal including the upper-side perspective image PT and bottom-side perspective image PB) supplied by the multiplexer 241 based on the attitude signals Sp showing that state, and outputs the same as the image signal S1. Thereby, as shown in (A) of FIG. 10, the display device 10 displays the display image D including the upper-side perspective image PT and the bottom-side perspective image PB. On the other hand, based on the attitude signal Sp, the shutter eyeglasses control section 13 controls the shutter eyeglasses 60 using the shutter control signal CTL, so as to make the left eye shutter 6L of the shutter eyeglasses 60 a closed state and make the right eye shutter 6R an open state during a period in which the frame image of the upper-side perspective image PT is displayed on the display section 12, and to make the left eye shutter 6L an open state and make the right eye shutter 6R a closed state during a period in which the frame image of the bottom-side perspective image PB is displayed. This makes it possible for an observer to visually confirm the bottom-side perspective image PB with the left eye and the upper-side perspective image PT with the right eye. That is, in the stereoscopic display system 1, the bottom-side perspective image PB is displayed as the left eye image L ((B) of FIG. 10) and the upper-side perspective image PT as the right eye image R ((C) of FIG. 10).

Thus, under a state where the shutter eyeglasses 60 are lying laterally, as shown in FIG. 2, the upper-side perspective image PT and the bottom-side perspective image PB having a parallax in the vertical direction to each other are displayed as the display image D ((A) of FIG. 10). Since the shutter eyeglasses 60 are lying laterally, the bottom-side perspective image PB corresponds to a perspective image viewed from the left-side of the observer. Similarly, the upper-side perspective image PT corresponds to a perspective image viewed from the right-side of the observer. That is, the upper-side perspective image PT and the bottom-side perspective image PB become perspective images having a parallax to each other in the lateral direction of the observer. Thereby, it is possible for the observer to recognize the display image D as a stereoscopic image.

In a state where the shutter eyeglasses 60 are lying in the right direction (FIG. 5C), the multiplexer 25 of the image processing section 20 selects the image signal STB1 (image signal including the upper-side perspective image PT and the bottom-side perspective image PB) supplied by the multiplexer 241 based on the attitude signal Sp showing that state, and outputs the same as the image signal S1. Thereby, as shown in (A) of FIG. 11, the display device 10 displays the display image D including the upper-side perspective image PT and the bottom-side perspective image PB. On the other hand, based on the attitude signal Sp, the shutter eyeglasses control section 13 controls the shutter eyeglasses 60 using the shutter control signal CTL, so as to make the left eye shutter 6L of the shutter eyeglasses 60 an open state and make the right eye shutter 6R a closed state during a period in which the frame image of the upper-side perspective image PT is displayed on the display section 12, and to make the left eye shutter 6L a closed state and make the right eye shutter 6R an open state during a period in which the frame image of the bottom-side perspective image PB is displayed. This makes it possible for an observer to observe the upper-side perspective image PT with the left eye and the bottom-side perspective image PB with the right eye. That is, in the stereoscopic display system 1, the upper-side perspective image PT is displayed as the left eye image L ((B) of FIG. 11) and the bottom-side perspective image PB as the right eye image R ((C) of FIG. 11).

Thus, in a state where the shutter eyeglasses 60 are lying laterally in the right direction, as shown in FIG. 2, the upper-side perspective image PT and the bottom-side perspective image PB having a parallax in the vertical direction to each other are displayed as the display image D ((A) of FIG. 11). Since the observer is lying in the right direction, the upper-side perspective image PT corresponds to a perspective image viewed from the left-side of the observer. Similarly, the bottom-side perspective image PB corresponds to a perspective image viewed from the right-side of the observer. That is, the upper-side perspective image PT and the bottom-side perspective image PB become perspective images having a parallax to each other in the lateral direction of the observer. Thereby, it is possible for the observer to recognize the display image D as a stereoscopic image.

As mentioned above, in the stereoscopic display system 1, the perspective images having a parallax to each other in the lateral direction of the observer are displayed regardless of the attitude of the observer. Thereby, even when the observer lies and sees the display image, it is possible for the observer to recognize the display image as a stereoscopic image. That is, in the same way as when observing existing two-dimensional images, it is possible to observe stereoscopic images without limiting the attitude of the observer. In particular, in the place of nursing care, for example, it is possible for bed-bound elderly people to observe a stereoscopic image regardless of the attitude. Also, for example, in a weightless environment such as in a space station, the attitude of the observer is indefinite because of weightlessness. Even in such a case, it is possible for the observer to observe stereoscopic images because the display device 10 displays perspective images in accordance with the attitude.

### [Effect]

According to the present embodiment, the left eye image and the right eye image based on the attitude of the shutter eyeglasses are displayed. Hence, it is possible for the observer to observe stereoscopic images regardless of the attitude.

Also, in the present embodiment, the left eye image and the right eye image are selected from the plurality of perspective images in the perspective image signal. Hence, it is possible to achieve a simple structure.

### [Modification 1-1]

In the above embodiment, the perspective images are displayed in accordance with the attitude under the state where the shutter eyeglasses 60 are horizontal and under the state where the shutter eyeglasses 60 are lying, however, it is not limited thereto. For example, in addition to these states, under a state where the shutter eyeglasses 60 are slanted, the perspective image in accordance with that attitude may be displayed. Descriptions will be given to this embodiment in the following.

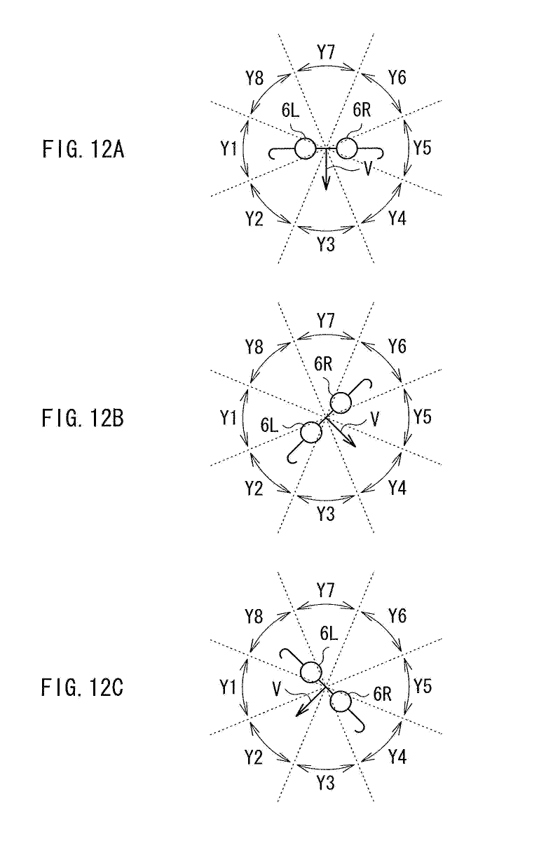

FIGS. 12A to 12C shows an example of an attitude of shutter eyeglasses 60B according to the present modification. FIG. 12A shows a state where the shutter eyeglasses 60B are horizontal. FIG. 12B shows a state where the shutter eyeglasses 60B are slanted in the left direction. FIG. 12C shows a state where the shutter eyeglasses 60B are slanted in the right direction.

An attitude detection section 63B of the shutter eyeglasses 60B detects any one of states where, for example, the shutter eyeglasses 60 are horizontal, lying in the left direction, slanted in the left direction, lying in the right direction, and slanted in the right direction, by detecting to which region a vector V is oriented among predetermined eight regions Y1 to Y8.

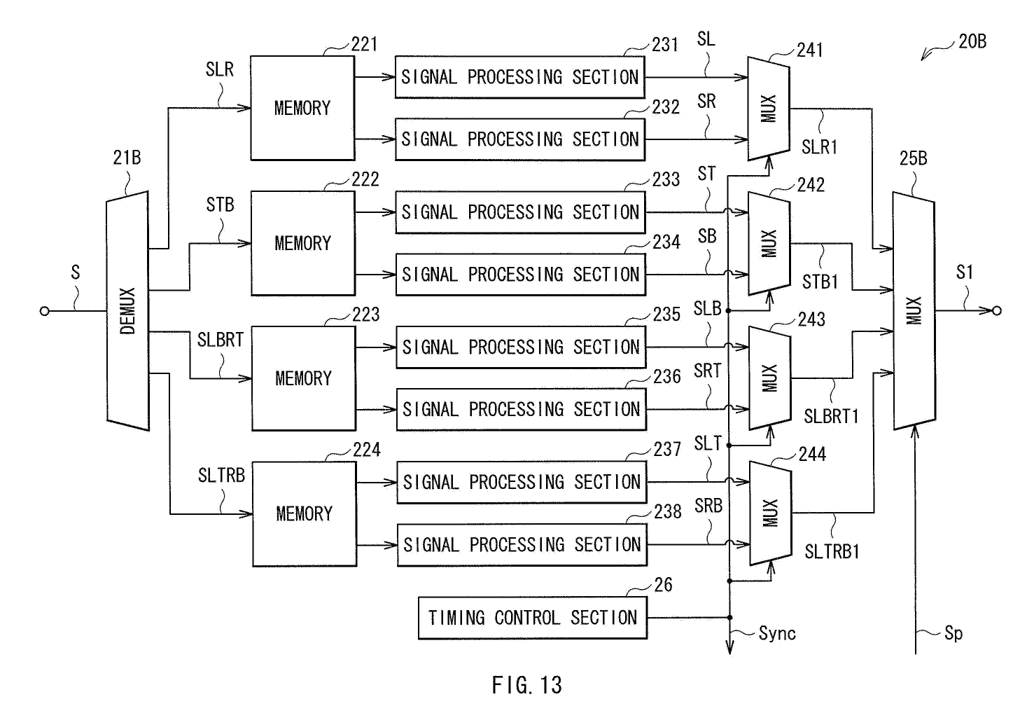

FIG. 13 shows an example of configuration of an image processing section 20B of a display device 10B according to the present modification. The image processing section 20B includes a demultiplexer 21B, memories 223 and 224, signal processing sections 235 to 238, and multiplexers 243, 244, and 25B.

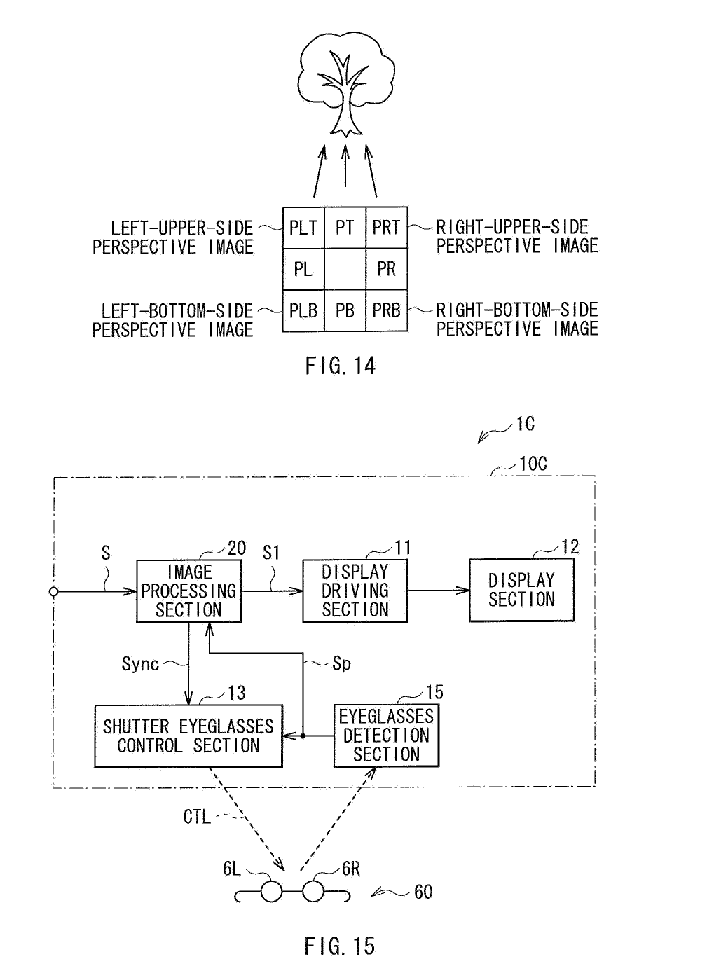

The demultiplexer 21B separates the image signal SLR including the left-side perspective image PL and the right-side perspective image PR from the perspective image signal S including eight perspective images (left-side perspective image PL, right-side perspective image PR, upper-side perspective image PT, bottom-side perspective image PB, left-bottom-side perspective image PLB, right-upper-side perspective image PRT, left-upper-side perspective image PLT, right-bottom-side perspective image PRB) shown in FIG. 14, to supply the same to the memory 221. The demultiplexer 21B further separates the image signal STB including the upper-side perspective image PT and the bottom-side perspective image PB therefrom to supply the same to the memory 222, separates the image signal SLBRT including the left-bottom-side perspective image PLB and the right-upper-side perspective image PRT therefrom to supply the same to the memory 223, and separates the image signal SLTRB including the left-upper-side perspective image PLT and the right-bottom-side perspective image PRB to supply the same to the memory 224.

The memories 223 and 224 are a frame memory that stores one frame of the image signals SLBRT and SLTRB, respectively. The signal processing sections 235 to 238 perform image signal processing for image signals supplied by the memories 223 and 224.

The multiplexer 243 multiplexes, based on the synchronous signal Sync, the image signal SLB supplied by the signal processing section 235 and the image signal SRT supplied by the signal processing section 236 such that the frame image of the left-bottom-side perspective image PLB and that of the right-upper-side perspective image PRT are arranged alternately, and outputs the resultant as the image signal SLBRT1. The multiplexer 244 multiplexes, based on the synchronous signal Sync, the image signal SLT supplied by the signal processing section 237 and the image signal SRB supplied by the signal processing section 238 such that the frame image of the left-upper-side perspective image PLT and that of the right-bottom-side perspective image PRB are arranged alternately, and outputs the resultant as the image signal SLTRB1.

The multiplexer 25B selects, based on the attitude signal Sp, one of the image signal SLR1 supplied by the multiplexer 241, the image signal STB1 supplied by the multiplexer 242, the image signal SLBRT1 supplied by the multiplexer 243, and the image signal SLTRB1 supplied by the multiplexer 244, and outputs the same. Specifically, the multiplexer 25B selects and outputs, to be mentioned later, the image signal SLBRT1 (the image signal including the left-bottom-side perspective image PLB and the right-upper-side perspective image PRT) when the shutter eyeglasses 60 are slanted in the left direction as shown in FIG. 12B, and selects and outputs the image signal SLTRB1 (the image signal including the left-upper-side perspective image PLT and the right-bottom-side perspective image PRB) when the shutter eyeglasses 60 are slanted in the right direction as shown in FIG. 12C.

### [Modification 1-2]

In the above embodiment, the shutter eyeglasses detect the attitude and the detection results are supplied to the display device, however, it is not limited thereto. For example, the display device may detect the attitude of the shutter eyeglasses, in place thereof. Descriptions will be given to this embodiment in the following.

FIG. 15 shows an example of configuration of a stereoscopic display system 1C according to the present modification. The stereoscopic display system 1C includes a display device 10C. The display device 10C includes a glasses detection section 15 that detects the attitude of the shutter eyeglasses 60. The glasses detection section 15 includes, for example, a camera (an image pick-up section). The camera recognizes the shutter eyeglasses 60 based on images of shutter eyeglasses 60 picked up by the camera, and detects the attitude thereof. With this configuration, it is possible for the stereoscopic display system 1C to detect the relative attitude of the shutter eyeglasses 60 viewed from the display device 10C. Thus, even when the display device 10C is disposed such that the display screen is vertically oriented, stereoscopic vision becomes possible with no special settings.

### Second Embodiment

Next, descriptions will be given to a stereoscopic display system 2 according to a second embodiment of the technology. In the present embodiment, a stereoscopic display system is configured using polarization eyeglasses (polarization-type eyeglasses). Note that the same reference numerals are given to components substantially similar or identical to those of the stereoscopic display system 1 according to the above-mentioned first embodiment, and descriptions will be omitted appropriately.

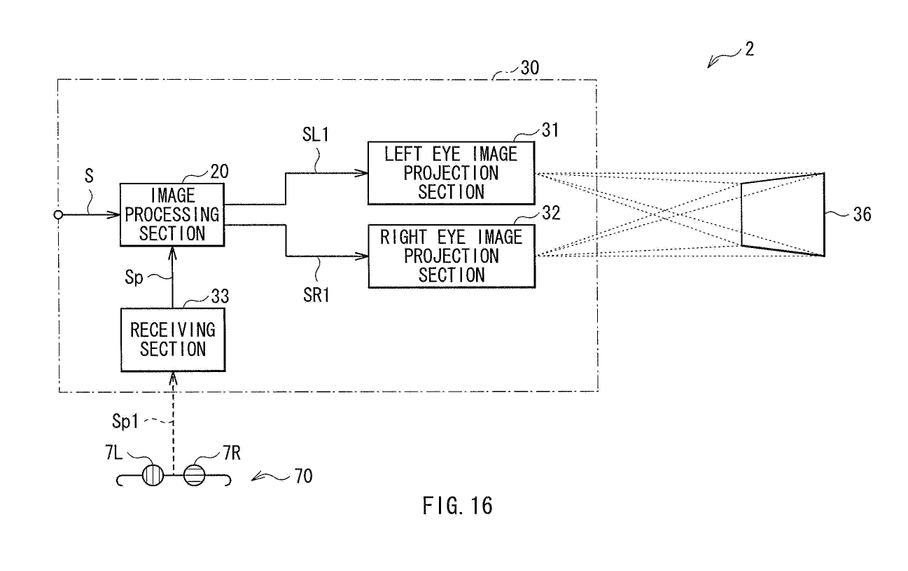

FIG. 16 shows an example of configuration of the stereoscopic display system 2. The stereoscopic display system 2 includes a display device 30, a screen 36, and polarization eyeglasses 70.

The display device 30 includes an image processing section 40, a left eye image projection section 31, a right eye image projection section 32, and a receiving section 33.

The image processing section 40, based on the perspective image signal S and the attitude signal Sp, generates the left eye image signal SL1 to supply the same to the left eye image projection section 31, and generates the right eye image signal SR1 to supply the same to the right eye image projection section 32.

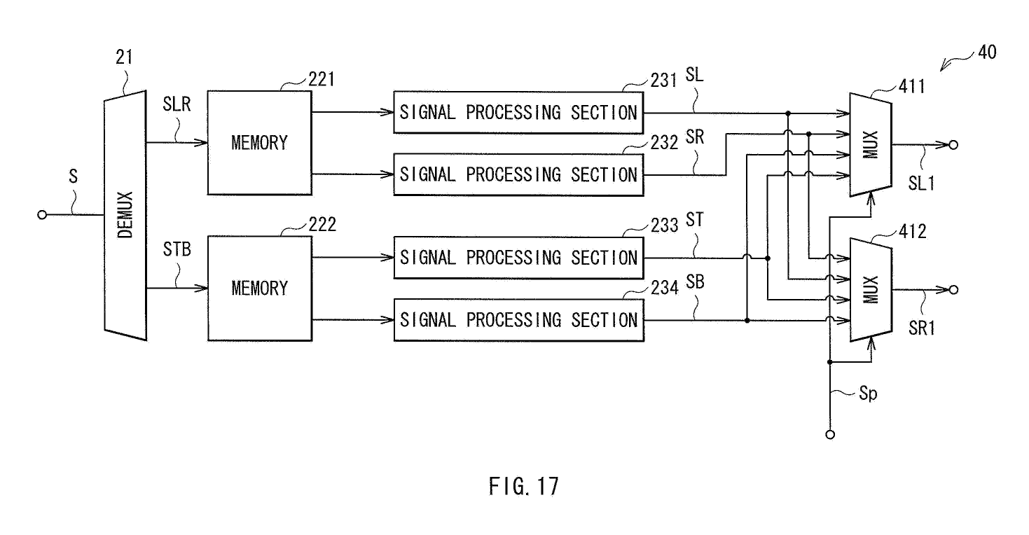

FIG. 17 shows an example of configuration of the image processing section 40. The image processing section 40 includes multiplexers 411 and 412. The multiplexers 411 and 412 select and output one of four image signals SL, SR, ST, and SB supplied by the signal processing sections 231 to 234 based on the attitude signal Sp. At this time, the multiplexers 411 and 412 select a mutually-paired perspective image signals, respectively. Specifically, under a state where the polarization eyeglasses 70 are horizontal (FIG. 5A), the multiplexer 411 selects the image signal SL to output the same as the left eye image signal SL1 and the multiplexer 412 selects the image signal SR to output the same as the right eye image signal SRL Under a state where the polarization eyeglasses 70 are lying in the left direction (FIG. 5B), the multiplexer 411 selects the image signal SB to output the same as the left eye image signal SL1 and the multiplexer 412 selects the image signal ST to output the same as the right eye image signal SRL Under a state where the polarization eyeglasses 70 are lying in the right direction (FIG. 5C), the multiplexer 411 selects the image signal ST to output the same as the left eye image signal SL1 and the multiplexer 412 selects the image signal SB to output the same as the right eye image signal SRL Thus, the image processing section 40 selects and outputs a pair of perspective images from the perspective image signals S based on the attitude of the polarization eyeglasses 70.

The left eye image projection section 31 projects images against the screen 36 based on the left eye image signal SL1. The right eye image projection section 32 projects images against the screen 36 based on the right eye image signal SRL The left eye image projection section 31 and the right eye image projection section 32 so project the images that polarization directions thereof intersect each other when both the left eye image projection section 31 and the right eye image projection section 32 project the images.

The receiving section 33 receives the attitude signal Sp1 supplied by the polarization eyeglasses 70 to supply them to the image processing section 40 as the attitude signal Sp.

The polarization eyeglasses 70 includes a left eye polarization plate 7L and a right eye polarization plate 7R. Transmission axes of the left eye polarization plate 7L and the right eye polarization plate 7R intersect with each other. Specifically, as shown in FIG. 16, the transmission axis of the left eye polarization plate 7L is in a longitudinal direction and that of the right eye polarization plate 7R is in a lateral direction. Thereby, it is possible for an observer to observe images projected on the screen 36 by the left eye image projection section 31 through the left eye polarization plate 7L and to observe images projected on the screen 36 by the right eye image projection section 32 through the right eye polarization plate 7R.

The polarization eyeglasses 70 include an attitude detection section 63 and a transmitter section 64, as in the shutter eyeglasses 60 of the above-mentioned first embodiment.

Here, the left eye polarization plate 7L and the right eye polarization plate 7R correspond to one embodiment of the “separation unit” according to the technology. The screen 36 corresponds to one embodiment of the “display section” according to the technology.

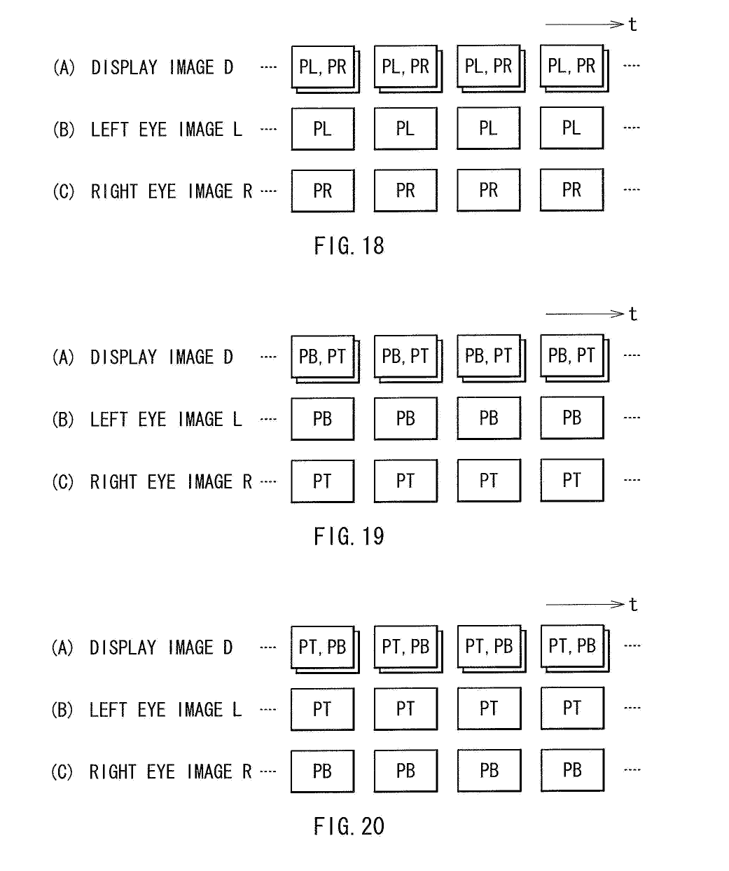

FIGS. 18 to 20 show an example of operation of the stereoscopic display system 2. Part (A) to Part (C) of FIG. 18 show the example of operation of a state where the polarization eyeglasses 70 is horizontal. Part (A) to Part (C) of FIG. 19 show the example of operation of a state where the polarization eyeglasses 70 is lying in the left direction. Part (A) to Part (C) of FIG. 20 show the example of operation of a state where the polarization eyeglasses 70 is lying in the right direction. Part (A) of each of FIGS. 18 to 20 shows the display image D on the screen 36. Part (B) of each of FIGS. 18 to 20 shows the left eye image L on the screen 36. Part (C) of each of FIGS. 18 to 20 show the right eye image R on the screen 36.

The attitude detection section 63 of the polarization eyeglasses 70 detects the attitude thereof in the same way as the embodiment illustrated in FIGS. 5A to 5C. The transmitter section 64 supplies the detection results thereof to the display device 30 as the attitude signal Sp1. In the display device 30, the receiving section 33 receives the attitude signal Sp1 to supply the same to the image processing section 40 as the attitude signal Sp.

In a state where the shutter eyeglasses 60 are horizontal (FIG. 5A), the image processing section 40 outputs, based on the attitude signal Sp showing the state thereof, the image signal SL (the image signal including the left-side perspective image PL) as the left eye image signal SL1, and outputs the image signal SR (the image signal including the right-side perspective image PR) as the right eye image signal SR1. Further, the left eye image projection section 31 projects the left-side perspective image PL onto the screen 36 and the right eye image projection section 32 projects the right-side perspective image PR onto the screen 36, by which both of those images are superimposed to be displayed as the display image D ((A) of FIG. 18). An observer observes the left-side perspective image PL through the left eye polarization plate 7L, and observes the right-side perspective image PR through the right eye polarization plate 7R. That is, the stereoscopic display system 2 displays the left-side perspective image PL as the left eye image L ((B) of FIG. 18), and displays the right-side perspective image PR as the right eye image R ((C) of FIG. 18). Thereby, it is possible for the observer to recognize the display image D as a stereoscopic image.

In a state where the shutter eyeglasses 60 are lying in the left direction (FIG. 5B), the image processing section 40 outputs, based on the attitude signal Sp showing the state thereof, the image signal SB (the image signal including the bottom-side perspective image PB) as the left eye image signal SL1, and outputs the image signal ST (the image signal including the upper-side perspective image PT) as the right eye image signal SRL Further, the left eye image projection section 31 projects the bottom-side perspective image PB onto the screen 36 and the right eye image projection section 32 projects the upper-side perspective image PT onto the screen 36, by which both of those images are superimposed to be displayed as the display image D ((A) of FIG. 19). An observer observes the bottom-side perspective image PB through the left eye polarization plate 7L, and observes the upper-side perspective image PT through the right eye polarization plate 7R. That is, the stereoscopic display system 2 displays the bottom-side perspective image PB as the left eye image L ((B) of FIG. 19), and at the same time, displays the upper-side perspective image PT as the right eye image R ((C) of FIG. 19). Thereby, it is possible for the observer to recognize the display image D as a stereoscopic image.

In a state where the shutter eyeglasses 60 are lying in the right direction (FIG. 5C), the image processing section 40 outputs, based on the attitude signal Sp showing the state thereof, the image signal ST (the image signal including the upper-side perspective image PT) as the left eye image signal SL1, and outputs the image signal SB (the image signal including the bottom-side perspective image PB) as the right eye image signal SRL Further, the left eye image projection section 31 projects the upper-side perspective image PT onto the screen 36 and the right eye image projection section 32 projects the bottom-side perspective image PB onto the screen 36, by which both of those images are superimposed to be displayed as the display image D ((A) of FIG. 20). An observer observes the upper-side perspective image PT through the left eye polarization plate 7L, and observes the bottom-side perspective image PB through the right eye polarization plate 7R. That is, the stereoscopic display system 2 displays the upper-side perspective image PT as the left eye image L ((B) of FIG. 20), and displays the bottom-side perspective image PB as the right eye image R ((C) of FIG. 20). Thereby, it is possible for the observer to recognize the display image D as a stereoscopic image.

According to the present embodiment, the stereoscopic display system is configured using the polarization eyeglasses. Hence, it is possible to simplify a structure of the glasses which an observer wears. Other advantages are similar to those according to the above-mentioned first embodiment.

### [Modification 2]

In the above embodiment, the display image D is displayed by polarizing the left eye image L and the right eye image R in the intersecting directions with each other to project those images on the screen 36, however, it is not limited thereto. The similar function may be achieved using a device such as the display section 12 of the above-mentioned first embodiment.

### Third Embodiment

Next, descriptions will be given to a stereoscopic display system 3 according to the third embodiment of the technology. The present embodiment is configured such that, by using the shutter eyeglasses, two or more observers observe the stereoscopic displaying. Descriptions will be given with reference to an example in which two observers are supposed in the following. Note that the same reference numerals are given to components substantially similar or identical to those of the stereoscopic display system 1 according to the above-mentioned first embodiment, and descriptions will be omitted appropriately.

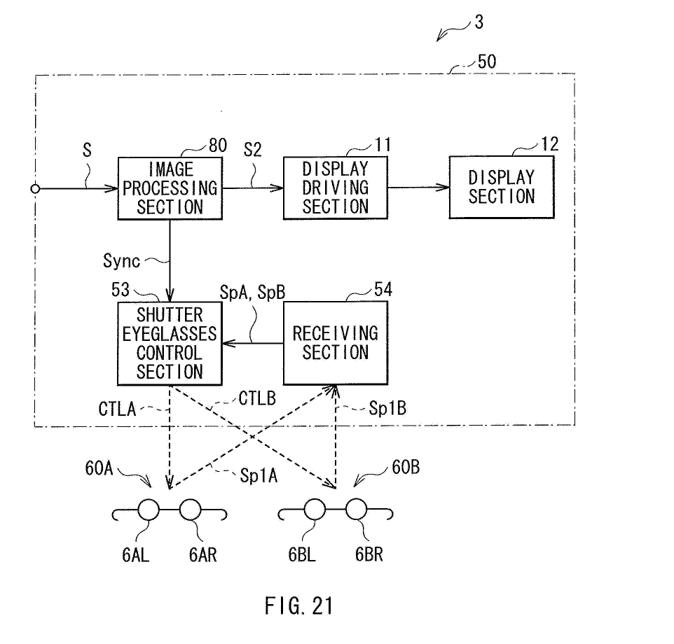

FIG. 21 shows an example of configuration of the stereoscopic display system 3. The stereoscopic display system 3 includes a display device 50 and a plurality of shutter eyeglasses 60A and 60B.

The display device 50 includes an image processing section 80, a shutter eyeglasses control section 53, and a receiving section 54.

The image processing section 80 generates, based on the perspective image signal S, the image signal S2 to supply the same to the display driving section 11, and generates the synchronous signal Sync to supply the same to the shutter eyeglasses control section 53.

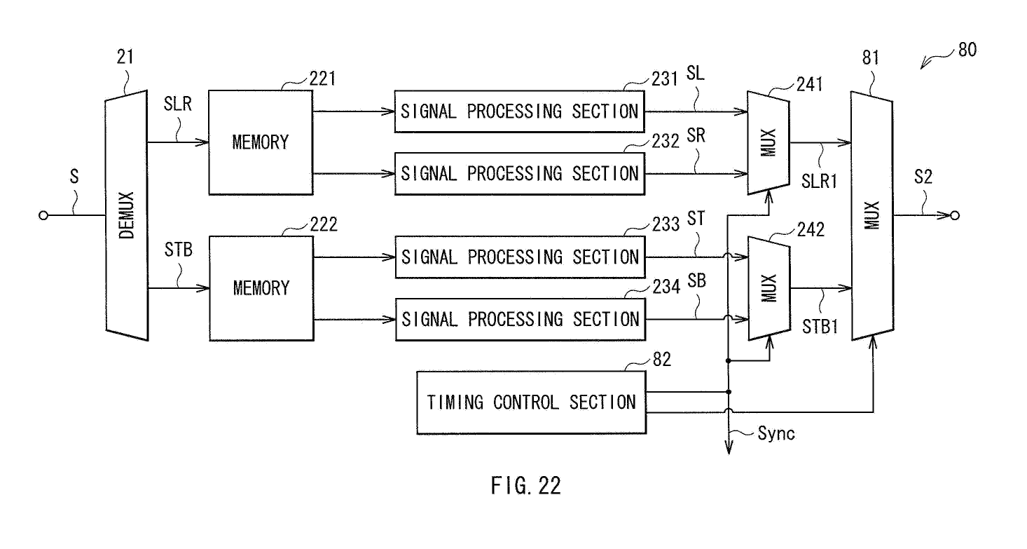

FIG. 22 shows an example of configuration of the image processing section 80. The image processing section 80 includes a timing control section 82 and a multiplexer 81. The timing control section 82 supplies the synchronous signal Sync to multiplexers 241 and 242 and the shutter eyeglasses control section 53, and supplies control signals to the multiplexer 81. The multiplexer 81 multiplexes, based on the control signals supplied by the timing control section 82, the image signal SLR1 (the image signal including the left-side perspective image PL and the right-side perspective image PR) supplied by the multiplexer 241 and the image signal STB1 (the image signals including the upper-side perspective image PT and the bottom-side perspective image PB) supplied by the multiplexer 242, outputs the resultant as the image signals S2. Specifically, the multiplexer 81 multiplexes those image signals so that, in this example, the frame image of the left-side perspective image PL, the frame image of the upper-side perspective image PT, the frame image of the right-side perspective image PR, and the frame image of the bottom-side perspective image PB are arranged in this order. Thus, the image processing section 80 is adapted to output two or more pairs of the perspective images (a pair of the left-side perspective images PL and the right-side perspective images PR and a pair of the upper-side perspective image PT and the bottom-side perspective image PB).

The shutter eyeglasses control section 53 controls the shutter eyeglasses 60A and 60B based on the synchronous signal Sync supplied by the image processing section 80 and the attitude signals SpA and SpB supplied by the receiving section 54. Specifically, the shutter eyeglasses control section 53 controls the shutter eyeglasses 60A by supplying the control signal CTLA to the glasses 60A, and controls the shutter eyeglasses 60B by supplying the control signals CTLB to the shutter eyeglasses 60B.

The receiving section 54 receives the attitude signal Sp1A supplied by the shutter eyeglasses 60A to supply the same to the shutter eyeglasses control section 53 as the attitude signal SpA. Also, the receiving section 54 receives the attitude signal Sp1B supplied by the shutter eyeglasses 60B to supply the same to the shutter eyeglasses control section 53 as the attitude signal SpB.

The shutter eyeglasses 60A and 60B are similar to the shutter eyeglasses 60 (FIG. 4) of the above-mentioned first embodiment. The shutter eyeglasses 60A include a left eye shutter 6AL and a right eye shutter 6AR. The shutter eyeglasses 60B include a left eye shutter 6BL and a right eye shutter 6BR.

In the stereoscopic display system 3, these configurations allow the shutter eyeglasses control section 53 of the display device 50 to independently control the shutter eyeglasses 60A and 60B based on the respective attitudes of the shutter eyeglasses 60A and 60B.

Next, while focusing on one (here, the shutter eyeglasses 60A) of the shutter eyeglasses, descriptions will be given to an example of operation of the stereoscopic display system 3.

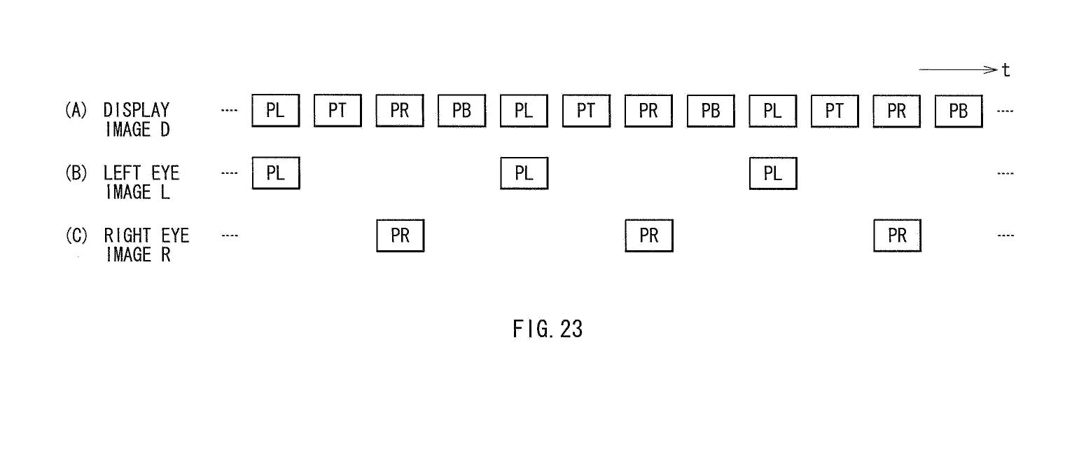

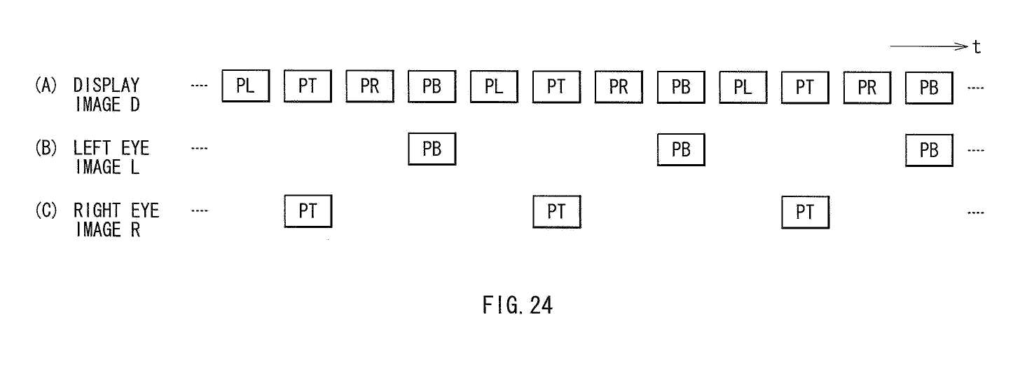

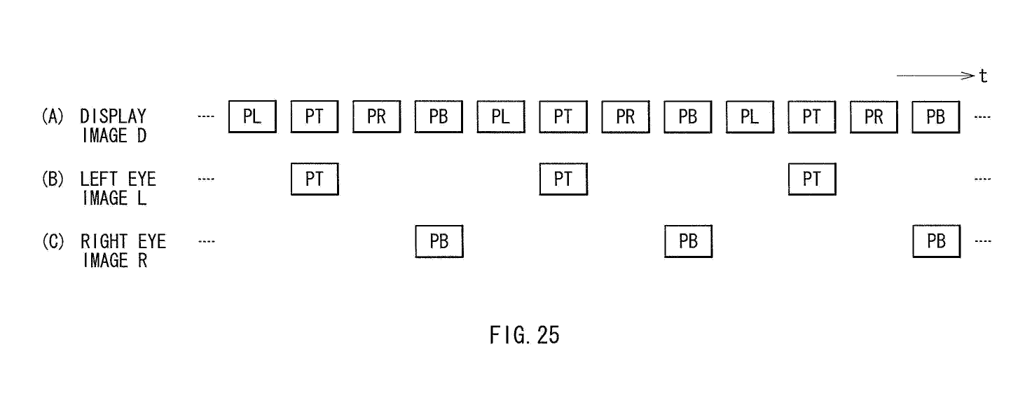

FIGS. 23 to 25 show examples of operation of the stereoscopic display system 3. Part (A) to Part (C) of FIG. 23 show an example of operation in a state where the shutter eyeglasses 60A are horizontal. Part (A) to Part (C) of FIG. 24 show an example of operation in a state where the shutter eyeglasses 60A are lying in the left direction. Part (A) to Part (C) of FIG. 25 shows an example of operation in a state where the shutter eyeglasses 60A are lying in the right direction. Part (A) of each of FIGS. 23 to 25 shows the display image D in the display section 12. Part (B) of each of FIGS. 23 to 25 shows the left eye image L in the display section 12. Part (C) of each of FIGS. 23 to 25 shows the right eye image R in the display section 12.

The attitude detection section 63 of the shutter eyeglasses 60A detects the attitude thereof in a similar way to the embodiment shown in FIGS. 5A to 5C. The transmitter section 64 supplies the detection results thereof to the display device 50 as the attitude signal Sp1A. In the display device 50, the receiving section 54 receives the attitude signal Sp1A to supply the same to the shutter eyeglasses control section 53 as the attitude signal SpA.

In the stereoscopic display system 3, the display section 12 displays, as shown in FIGS. 23 to 25 regardless of the attitudes of the observers, the frame image of the left-side perspective image PL, the frame image of the upper-side perspective image PT, the frame image of the right-side perspective image PR, and the frame image of the bottom-side perspective image PB in a circulate manner and in a time-divisional fashion as the display images D (Part (A) of each of FIG. 23, FIG. 24, and FIG. 25).

In a state where the shutter eyeglasses 60A are horizontal (FIG. 5A), the shutter eyeglasses control section 53 controls, based on the attitude signal SpA showing the state thereof, the shutter eyeglasses 60A using the shutter control signal CTLA, such that the left eye shutter 6AL of the shutter eyeglasses 60A is made to be in an open state and the right eye shutter 6AR is made to be in a closed state during a period when the frame image of the left-side perspective image PL is displayed on the display section 12, and the left eye shutter 6AL is made to be in a closed state and the right eye shutter 6AR is made to be in an open state during a period when the frame image of the right-side perspective image PR is displayed. Thus, it is possible for the observer to observe the left-side perspective image PL with the left eye and to observe the right-side perspective image PR with the right eye. That is, the stereoscopic display system 3 displays the left-side perspective image PL as the left eye image L ((B) of FIG. 23), and displays the right-side perspective image PR as the right eye image R ((C) of FIG. 23).

In a state where the shutter eyeglasses 60A are lying in the left direction, the shutter eyeglasses control section 53 controls, based on the attitude signal SpA showing the state thereof, the shutter eyeglasses 60A using the shutter control signal CTLA, such that the left eye shutter 6AL of the shutter eyeglasses 60A is made to be in an open state and the right eye shutter 6AR is made to be in a closed state during a period when the frame image of the bottom-side perspective image PB is displayed on the display section 12, and the left eye shutter 6AL is made to be in a closed state and the right eye shutter 6AR is made to be in an open state during a period when the frame image of the upper-side perspective image PT is displayed. Thus, it is possible for the observer to observe the bottom-side perspective image PB with the left eye and to observe the upper-side perspective image PT with the right eye. That is, the stereoscopic display system 3 displays the bottom-side perspective image PB as the left eye image L ((B) of FIG. 24), and displays the upper-side perspective image PT as the right eye image R ((C) of FIG. 24).

In a state where the shutter eyeglasses 60A are lying in the right direction, the shutter eyeglasses control section 53 controls, based on the attitude signal SpA showing the state thereof, the shutter eyeglasses 60A using the shutter control signal CTLA, such that the left eye shutter 6AL of the shutter eyeglasses 60A is made to be in an open state and the right eye shutter 6AR is made to be in a closed state during a period when the frame image of the upper-side perspective image PT is displayed on the display section 12, and the left eye shutter 6AL is made to be in a closed state and the right eye shutter 6AR is made to be in an open state during a period when the frame image of the bottom-side perspective image PB is displayed. Thus, it is possible for the observer to observe the upper-side perspective image PT with the left eye and to observe the bottom-side perspective image PB with the right eye. That is, the stereoscopic display system 3 displays the upper-side perspective image PT as the left eye image L ((B) of FIG. 25), and displays the bottom-side perspective image PB as the right eye image R ((C) of FIG. 25).

According to the present embodiment, two or more pairs of perspective images are displayed, and the opening-closing timing of each shutter eyeglasses is independently controlled in response to the attitude of each shutter eyeglasses. Hence, it is possible for two or more observers to observe stereoscopic vision according to respective attitudes. Other effects are similar to those of the above-mentioned first embodiment.

### [Modification 3]

In the above embodiment, two shutter eyeglasses 60A and 60B are employed, however, it is not limited thereto. Only one shutter eyeglasses may be used, or alternatively, three or more shutter eyeglasses may be used.

Although the descriptions have been given with reference to some embodiments and modifications, the technology is not limited thereto and a variety of modifications are allowable.

For example, in the above second and third embodiments, the polarization eyeglasses or the shutter eyeglasses have the attitude detection section to supply the detection results of the attitude to the display device, however, it is not limited thereto. In place of the above, the display device may include the glasses detection section that detects the attitude of the glasses as in the modification (FIG. 15) of the above-mentioned first embodiment.

Also, in the above-mentioned embodiments and the modifications, the display device displays images based only on the supplied perspective images, however, it is not limited thereto. For example, a television device may be allowable that has a tuner, selects desired perspective image signals from two or more perspective image signals supplied by broadcasting, and display images based on the selected perspective images.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A stereoscopic display system, comprising:
one or more eyeglasses devices; and
a display device selecting perspective images from a plurality of supplied perspective images to display the selected perspective images, and obtaining attitude information which represents a tilt of each of the eyeglasses devices relative to a horizontal direction,
wherein each of the eyeglasses devices optically separates a left eye image and a right eye image from the selected perspective images displayed on the display device, based on the obtained attitude information.

2. The stereoscopic display system according to claim 1, wherein
each of the eyeglasses devices includes an attitude detection section detecting its own attitude, and
the display device obtains the attitude information from the attitude detection section in each of the eyeglasses devices.

3. The stereoscopic display system according to claim 1, wherein
the display device includes an eyeglasses detection section detecting the attitude of each of the eyeglasses devices.

4. The stereoscopic display system according to claim 3, wherein
the eyeglasses detection section picks up an image of each of the eyeglasses devices and detects the attitude of each of the eyeglasses devices based on the picked-up images.

5. The stereoscopic display system according to claim 1, wherein
the display device selects a pair of perspective images from the plurality of supplied perspective images based on the attitude information.

6. The stereoscopic display system according to claim 5, wherein
each of the eyeglasses devices is configured as a shutter-type eyeglasses having a left eye shutter and a right eye shutter, and
the display device displays the pair of perspective images alternately in a time-divisional manner, and controls the shutter-type eyeglasses to allow the left eye shutter and the right eye shutter to open and to close with a timing based on the attitude information.

7. The stereoscopic display system according to claim 5, wherein
each of the eyeglasses devices is configured as a polarization-type eyeglasses having a left eye polarization plate and a right eye polarization plate which have transmission axes intersecting with each other, and
the display device displays, based on the attitude information, the left eye image and the right eye image as the pair of perspective image while allowing the left eye image and the right eye image to be polarized in intersecting directions with each other.

8. The stereoscopic display system according to claim 7, wherein
the display device displays the left eye image to allow an observer to observe the left eye image through the left eye polarization plate, and displays the right eye image to allow the observer to observe the right eye image through the right eye polarization plate.

9. The stereoscopic display system according to claim 1, wherein
each of the eyeglasses devices is configured as a shutter-type eyeglasses having a left eye shutter and a right eye shutter, and
the display device obtains the attitude information for each of the shutter-type eyeglasses to display the plural pairs of perspective images, and controls each of the shutter-type eyeglasses to allow the left eye shutter and the right eye shutter to open and to close with a timing based on the attitude information.

10. The stereoscopic display system according to claim 9, wherein
two pairs of perspective images are used as the plural pairs of perspective images.

11. An eyeglasses device, comprising:
an attitude detection section detecting attitude information which represents a tilt relative to a horizontal direction; and
a separation unit optically separating a left eye image and a right eye image from perspective images selected from a plurality of supplied perspective images and displayed on a display device, based on the obtained attitude information.

12. A display device, comprising:
a display device selecting perspective images from a plurality of supplied perspective images to display the selected perspective images; and
an acquisition unit obtaining attitude information which represents a tilt of one or more eyeglasses devices relative to a horizontal direction,
wherein each of the eyeglasses devices optically separates a left eye image and a right eye image from the selected perspective images displayed on the display device, based on the obtained attitude information.

13. An image display system, comprising:
an image pick-up unit picking up a plurality of perspective images from an object, and
a stereoscopic display system performing stereoscopic display based on the plurality of perspective images,
the stereoscopic display system including:
one or more eyeglasses devices; and
a display device selecting perspective images from the plurality of supplied perspective images to display the selected perspective images, and obtaining attitude information which represents a tilt of each of the eyeglasses devices relative to a horizontal direction,
wherein each of the eyeglasses devices optically separates a left eye image and a right eye image from the selected perspective images displayed on the display device, based on the obtained attitude information.

14. The image display system according to claim 13, wherein the image pick-up unit includes:
an image pick-up lens having an aperture stop;
an image pick-up device receiving light while holding a traveling direction of a light beam thereto, to output image data based on the received light;
a micro lens array section disposed on an image plane of the image pick-up lens to include a plurality of micro lenses each allocated to two or more pixels of the image pick-up device; and
an image processing section generating the plurality of perspective images based on the image data.
